(19) United States
(12) Patent Application Publication
(10) Pub. No.: US 2013/0085277 A1
(43) Pub. Date: Apr. 4, 2013

(54) PROCESS FOR THE PREPARATION OF BORTEZOMIB

(71) Applicants: Satish Kumar, Kurukshetra (IN); Venugopal Venkatarama Durvasula, Vizianagaram (IN); Parendu Dhirajlal Rathod, Gurgaon (IN); Ram Chander Aryan, New Delhi (IN)

(72) Inventors: Satish Kumar, Kurukshetra (IN); Venugopal Venkatarama Durvasula, Vizianagaram (IN); Parendu Dhirajlal Rathod, Gurgaon (IN); Ram Chander Aryan, New Delhi (IN)

(73) Assignee: RANBAXY LABORATORIES LIMITED, New Delhi, Delhi (IN)

(21) Appl. No.: 13/577,708

(22) PCT Filed: Feb. 9, 2011
(86) PCT No.: PCT/IB2011/050555

§ 371 Date: Oct. 11, 2012

(30) Foreign Application Priority Data
Feb. 9, 2010 (IN) 273/DEL/2010

(51) Int. Cl. C07F 5/02

(52) U.S. Cl. CPC C07F 5/025
USPC 544/229; 558/288

(57) ABSTRACT

The present invention relates to a process for the preparation of bortezomib (Formula I) and its intermediates.

### FIELD OF THE INVENTION

The present invention relates to a process for the preparation of bortezomib and its intermediates.

### BACKGROUND OF THE INVENTION

Bortezomib, a monomeric boronic acid, is chemically [(1R)-3-methyl-1-[[(2S)-1-oxo-3-phenyl-2-[(pyrazinylcarbonyl)amino]propyl]amino]butyl]boronic acid of Formula I.

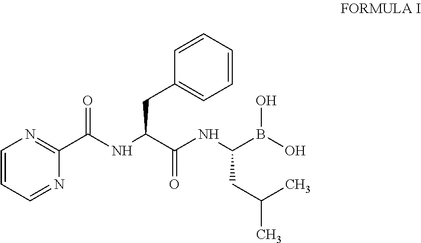 [SMILES: CC(C)C[C@H](NC(=O)[C@H](Cc1ccccc1)NC(=O)c1ncccn1)B(O)O]

Bortezomib is useful for the treatment of patients with multiple myeloma and patients with mantle cell lymphoma.

According to U.S. Publication 2005/240047, bortezomib can also exist in the form of a boronic acid anhydride of Formula IA.

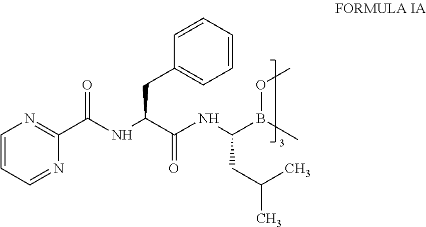 [SMILES: COB(C)[C@H](CC(C)C)NC(=O)[C@H](Cc1ccccc1)NC(=O)c1ncccn1]

U.S. Publication 2005/240047 describes the following process for the preparation of bortezomib or a boronic acid anhydride of Formula IA.

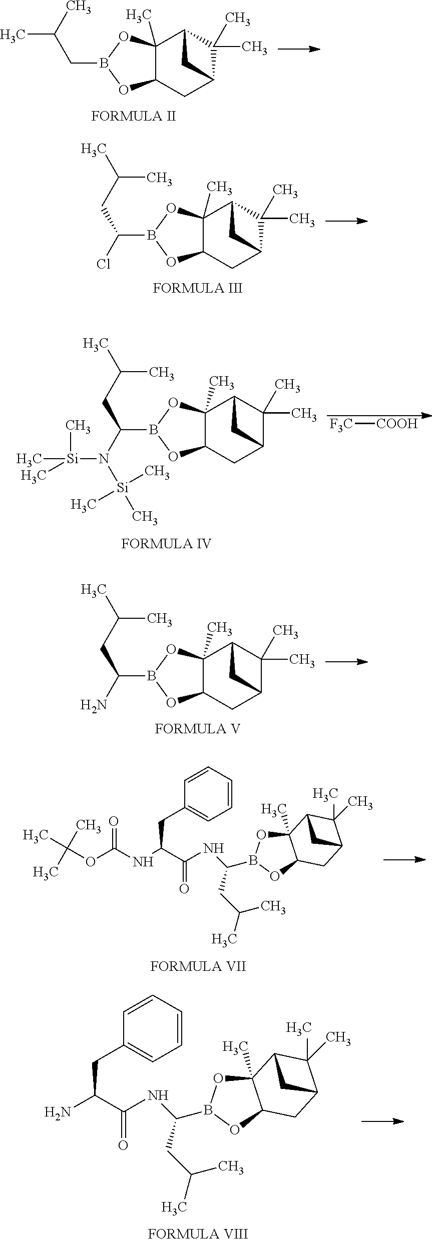

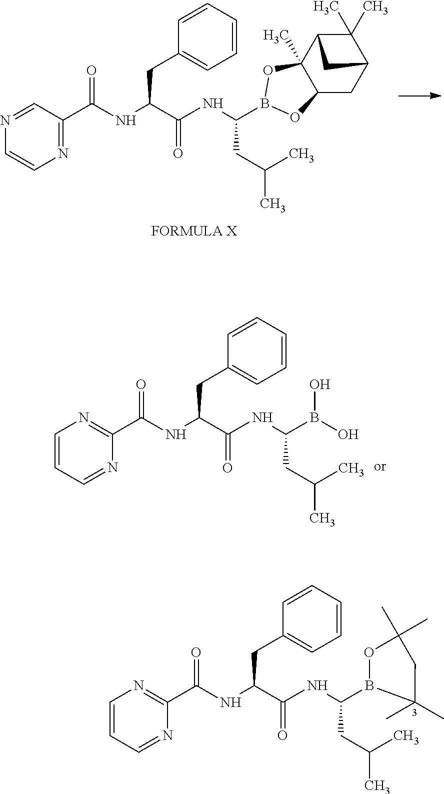 [SMILES: CC(C)C[C@H](NC(=O)[C@H](Cc1ccccc1)NC(=O)c1cnccn1)B1O[C@@H]2C[C@@H]3C[C@@H](C3(C)C)[C@]2(C)O1 ; CC(C)C[C@H](NC(=O)[C@H](Cc1ccccc1)NC(=O)c1ncccn1)B(O)O ; "or" ; CC(C)C[C@H](NC(=O)[C@H](Cc1ccccc1)NC(=O)c1ncccn1)B1OC(C)(C)CC1(C)C]

The above process involves the Lewis acid promoted rearrangement of the compound of Formula II in tertiary-butyl methyl ether and dichloromethane to obtain the compound of Formula III. U.S. Publication 2005/240047 says that the use of an ether solvent that has low miscibility with water such as tertiary-butyl methyl ether in said step obviates the requirement of rigorously dried equipments, solvents and reagents. U.S. Publication 2005/240047 also mentions that failure to use rigorously dried equipments, solvents and reagents result in a dramatic reduction in diastereomeric ratio.

Further process steps provided in U.S. Publication 2005/240047 for preparing bortezomib or a boronic acid anhydride from the compound of Formula V invariably involve the use of solvent exchange and tedious work-up procedure. For example, after the preparation of compound of Formula VII in dichloromethane, the solvent system is exchanged with ethyl acetate. The solvent exchange requires dividing the reaction mixture into two portions in two rotary evaporator flasks. The deprotection of the compound of Formula VII into the compound of Formula VIII is carried out by bubbling of hydrogen chloride gas into the ethyl acetate solution containing a compound of Formula VII. The above step requires slurry washing with heptane for 2 hours after the deprotection.

WO 2009/036281 describes a process for the preparation of compound of Formula III by reacting the compound of Formula II with lithium diisopropylamide in the presence of a Lewis acid, tetrahydrofuran and 4 to 8 moles of dichloromethane per mole of the compound of Formula II. It further mentions that excess of dichloromethane is needed for proper layer separation after quenching the reaction mixture with aqueous acid solution.

WO 2009/004350 describes a process for the preparation of bortezomib by exposing the compound of Formula II to lithium amide base and a transition metal halide in a solvent comprising at least 95% tetrahydrofuran by volume to provide the compound of Formula III, which is further converted into bortezomib.

### SUMMARY OF THE INVENTION

The present inventors have developed industrially advantageous and efficient processes for the preparation of bortezomib and its intermediates, which avoids the drawbacks associated with reported processes. For example, the present processes do not require excessive use of halogenated hydrocarbon solvent for preparing the compound of Formula III; they avoid the use of water-immiscible ether solvents without impacting the yield; they do not require additional slurry washing steps for purifying or isolating the compound of Formula VIII; and they do not involve any solvent exchange and such tedious work-up procedures. Thus, the present processes are economic and industrially scalable for the preparation of bortezomib and its intermediates.

### DETAILED DESCRIPTION OF THE INVENTION

A first aspect of the present invention provides a process for the preparation of (3aS,4S,6S,7aR)-2-(1-chloro-3-methylbutyl)-3a,5,5-trimethylhexahydro-4,6-methano-1,3,2-benzodioxaborole of Formula III or its salts,

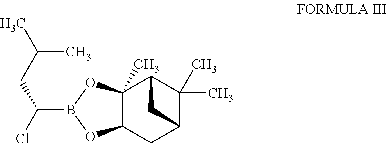 [SMILES: CC(C)C[C@@H](Cl)B1O[C@@H]2C[C@@H]3C[C@@H](C3(C)C)[C@]2(C)O1]

wherein the process comprises reacting (3aS,4S,6S,7aR)-3a,5,5-trimethyl-2-(2-methylpropyl)hexahydro-4,6-methano-1,3,2-benzodioxaborole of Formula II or its salts

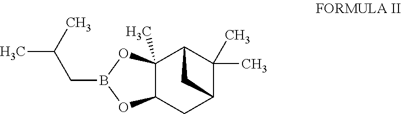 [SMILES: CC(C)CB1O[C@@H]2C[C@@H]3C[C@@H](C3(C)C)[C@]2(C)O1]

with lithium amide base and a Lewis acid in the presence of a water-miscible ether solvent and a halogenated hydrocarbon solvent to obtain (3aS,4S,6S,7aR)-2-(1-chloro-3-methylbutyl)-3a,5,5-trimethylhexahydro-4,6-methano-1,3,2-benzodioxaborole of Formula III or its salts, wherein the halogenated hydrocarbon solvent is less than about 3.8 molar equivalents per mole of the compound of Formula II.

A second aspect of present invention provides a process for the preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts,

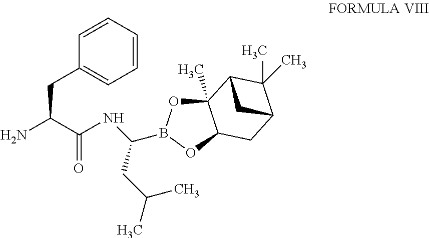 [SMILES: CC(C)C[C@H](NC(=O)[C@@H](N)Cc1ccccc1)B1O[C@@H]2C[C@@H]3C[C@@H](C3(C)C)[C@]2(C)O1]

wherein the process comprises contacting tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII

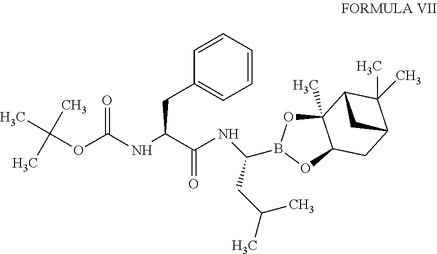 [SMILES: CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]

with an acid in the presence of a hydrocarbon solvent to obtain the compound of Formula VIII or its salts.

A third aspect of the present invention provides a process for the preparation of bortezomib of Formula I or a boronic acid anhydride of Formula IA comprising

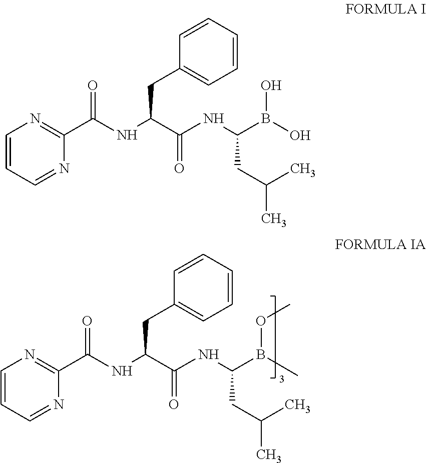 [SMILES: CC(C)C[C@H](NC(=O)[C@H](Cc1ccccc1)NC(=O)c1ncccn1)B(O)O ; COB(C)[C@H](CC(C)C)NC(=O)[C@H](Cc1ccccc1)NC(=O)c1ncccn1]

a) reacting (3aS,4S,6S,7aR)-3a,5,5-trimethyl-2-(2-methylpropyl)hexahydro-4,6-methano-1,3,2-benzodioxaborole of Formula II or its salts

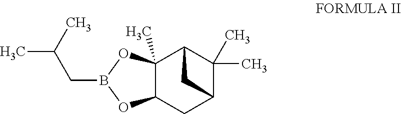 [SMILES: CC(C)CB1O[C@@H]2C[C@@H]3C[C@@H](C3(C)C)[C@]2(C)O1]

with lithium amide base and Lewis acid in the presence of a water miscible ether solvent and a halogenated hydrocarbon solvent to obtain (3aS,4S,6S,7aR)-2-(1-chloro-3-methylbutyl)-3a,5,5-trimethylhexahydro-4,6-methano-1,3,2-benzodioxaborole of Formula III or its salts,

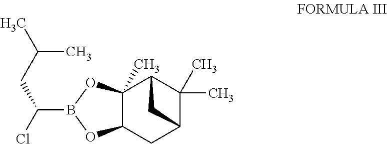 [SMILES: CC(C)C[C@@H](Cl)B1O[C@@H]2C[C@@H]3C[C@@H](C3(C)C)[C@]2(C)O1]

wherein the halogenated hydrocarbon solvent is less than about 3.8 molar equivalents per mole of compound of Formula II,
b) reacting the compound of Formula III or its salts with M¹-N(Si(CH₃)₃)₂, where M¹ is an alkali metal to obtain 1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine of Formula IV or its salts,

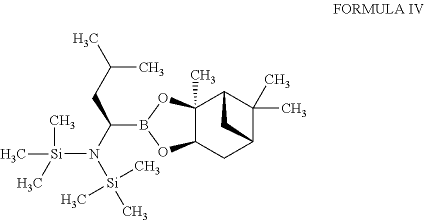

c) desilylating the compound of Formula IV or its salts to obtain (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts,

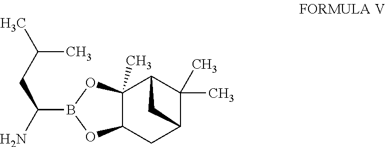 [SMILES: CC(C)C[C@H](N)B1O[C@@H]2C[C@@H]3C[C@@H](C3(C)C)[C@]2(C)O1]

d) coupling the compound of Formula V or its salts with N-(tert-butoxycarbonyl)-L-phenylalanine of Formula VI to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII,

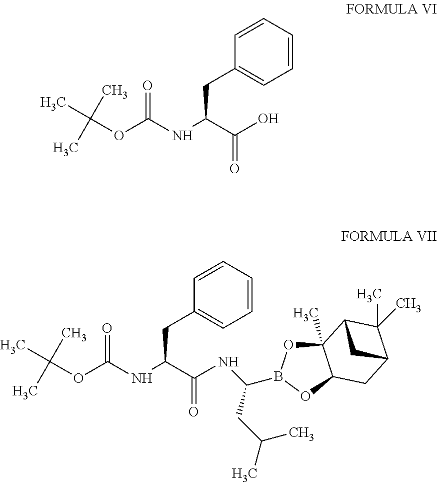 [SMILES: CC(C)(C)OC(=O)N[C@@H](Cc1ccccc1)C(=O)O ; CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]

e) deprotecting the compound of Formula VII in the presence of a hydrocarbon solvent to obtain N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts,

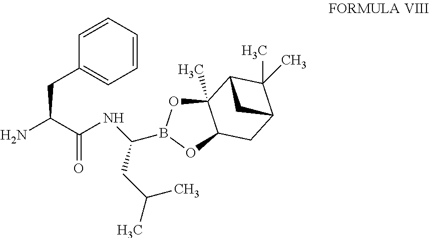 [SMILES: CC(C)C[C@H](NC(=O)[C@@H](N)Cc1ccccc1)B1O[C@@H]2C[C@@H]3C[C@@H](C3(C)C)[C@]2(C)O1]

f) coupling the compound of Formula VIII or its salts with pyrazine-2-carboxylic acid of Formula IX to obtain N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X, and

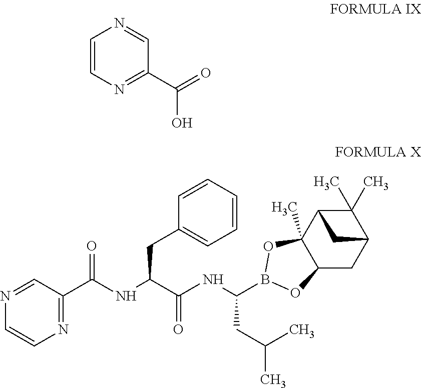 [SMILES: O=C(O)c1cnccn1 ; CC(C)C[C@H](NC(=O)[C@H](Cc1ccccc1)NC(=O)c1cnccn1)B1O[C@@H]2C[C@@H]3C[C@@H](C3(C)C)[C@]2(C)O1]

g) deprotecting the compound of Formula X to obtain bortezomib or a boronic acid anhydride of Formula IA.

(3aS,4S,6S,7aR)-3a,5,5-Trimethyl-2-(2-methylpropyl)hexahydro-4,6-methano-1,3,2-benzodioxaborole of Formula II or its salts may be prepared according to the method provided in U.S. Publication 2005/240047 or PCT application WO 2009/004350. (3aS,4S,6S,7aR)-3a,5,5-trimethyl-2-(2-methylpropyl)hexahydro-4,6-methano-1,3,2-benzodioxaborole or its salts is reacted with lithium amide base and a Lewis acid in the presence of a water-miscible ether solvent and a halogenated hydrocarbon solvent. The water-miscible ether solvent may be, for example, tetrahydrofuran. The water-miscible ether solvent comprises about 20% to about 93% by volume of the reaction mixture. The halogenated hydrocarbon solvent may be selected from the group consisting of dichloromethane, dichloroethane, chloroform and carbon tetrachloride. The halogenated hydrocarbon solvent is less than about 3.8 molar equivalents per mole of compound of Formula II. The Lithium amide base may be selected from the group consisting of lithium diisopropylamide, lithium diethylamide and lithium dimethylamide. The Lewis acid used could be any suitable Lewis acid generally known in organic chemistry. More specifically, it may be selected from the group consisting of zinc chloride, zinc bromide, boron trifluoride, boron trichloride, ferric chloride, ferric bromide and aluminum trichloride. The reaction may be carried out at a temperature of about 20° C. to about −80° C. for about 1 hour to about 100 hours. The reaction may be facilitated by stirring the reaction mixture. (3aS,4S,6S,7aR)-2-(1-chloro-3-methylbutyl)-3a,5,5-trimethylhexahydro-4,6-methano-1,3,2-benzodioxaborole of Formula III or its salts may be optionally isolated. The isolation may be carried out by filtration, extraction, distillation, pH adjustment, concentration, decantation, or a combination thereof.

(3aS,4S,6S,7aR)-2-(1-chloro-3-methylbutyl)-3a,5,5-trimethylhexahydro-4,6-methano-1,3,2-benzodioxaborole of Formula III or its salts is reacted with M¹-N(Si(CH₃)₃)₂, where M¹ is an alkali metal, to obtain 1,1,1-trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethyl silyl)silanamine of Formula IV, or its salts. The alkali metal may be, for example, lithium, sodium or potassium. The compound, M¹-N(Si(CH₃)₃)₂, may be, for example, lithium bis(trimethylsilyl)amide, sodium bis(trimethylsilyl)amide and potassium bis(trimethylsilyl)amide. The reaction may be carried out at a temperature of about 20° C. to about −80° C. for about 1 hour to about 100 hours. 1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine of Formula IV or its salts may be optionally isolated. The isolation may be carried out by filtration, extraction, distillation, pH adjustment, concentration, decantation, or a combination thereof.

1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine of Formula IV or its salts is desilylated in the presence of an organic solvent to obtain (1R)-3-methyl-1-[(3aS,4S,6S,7aR)-3a,5,5-trimethylhexahydro-4,6-methano-1,3,2-benzodioxaborol-2-yl]butan-1-amine of Formula V, or its salts. The desilylation may be carried out using an acid. The organic solvent may be an ether solvent or an ester solvent. The ether solvent may be selected from the group consisting of dimethyl ether, diethyl ether, diisopropyl ether, tetrahydrofuran, dimethoxyethane, dimethoxymethane, diglyme, 1,4-dioxane, ethyl-tert-butyl ether, methyl-tert-butyl ether and methoxy ethane, or a mixture thereof. The ester solvent may be selected from the group consisting of ethyl acetate, methyl acetate, isopropyl acetate and butyl acetate, or a mixture thereof. The acid may be an organic acid, for example, trifluoroacetic acid, or an inorganic acid. (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts may be optionally isolated. The isolation may be carried out by filtration, extraction, distillation, pH adjustment, concentration, decantation, or a combination thereof.

(1R)-3-methyl-1-[(3aS,4S,6S,7aR)-3a,5,5-trimethylhexahydro-4,6-methano-1,3,2-benzodioxaborol-2-yl]butan-1-amine of Formula V or its salts is coupled with N-(tert-butoxycarbonyl)-L-phenylalanine of Formula VI in the presence of a coupling agent, a base and an organic solvent to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII. The coupling agent may be selected from the group consisting of O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate and 1-ethyl-3-(3-dimethylaminopropyl)carbodiimide. The base may be selected from the group consisting of metal alkoxides, alkali metal hydroxides, alkali metal carbonates, alkali metal hydrides and alkylamines. The base may be, for example, N,N-diisopropylethylamine. The organic solvent may be selected from the group consisting of dichloromethane, dichloroethane, chloroform, dimethylformamide and 1,4-dioxane, or a mixture thereof. The tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII may be optionally isolated. The isolation may be carried out by filtration, extraction, distillation, pH adjustment, concentration, decantation, or a combination thereof.

Tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII is deprotected in the presence of a hydrocarbon solvent to obtain N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII, or its salts. The deprotection may be carried out in the presence of an acid. The acid may be an organic acid or inorganic acid, for example, trifluoroacetic acid, hydrochloric acid, hydrobromic acid or sulfuric acid. The hydrocarbon solvent may be an aromatic hydrocarbon solvent. The aromatic hydrocarbon solvent may be, for example, toluene or xylene, or a mixture thereof. N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts may be optionally isolated by filtration, concentration or decantation, or a combination thereof.

N-{(1S)-3-Methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts is coupled with pyrazine-2-carboxylic acid of Formula IX in the presence of a coupling reagent, a base and an organic solvent to obtain N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X. The coupling agent may be selected from the group consisting of O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate and 1-ethyl-3-(3-dimethylaminopropyl)carbodiimide. The base may be an organic base or an inorganic base, for example, metal alkoxides, alkali metal hydroxides, alkali metal carbonates, alkali metal hydrides or alkylamines. The base may be an alkylamine, for example, N,N-diisopropylethylamine. The organic solvent may be a polar solvent or a non polar solvent. The organic solvent may be selected from the group consisting of dichloromethane, dichloroethane, chloroform, dimethylformamide and 1,4-dioxane, or a mixture thereof. N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X may be optionally isolated. The isolation may be carried out by filtration, extraction, distillation, pH adjustment, concentration, decantation, or a combination thereof.

N-{(1R)-3-Methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X is deprotected with an acid, an organic boronic acid acceptor and an alcoholic solvent. The acid may be an organic acid or inorganic acid, for example trifluoroacetic acid, hydrochloric acid or hydrobromic acid. The organic boronic acid acceptor may be, for example, isobutyl boronic acid. The alcoholic solvent may be selected from the group consisting of methanol, ethanol, n-propanol, propan-2-ol, butan-1-ol and butan-2-ol, or a mixture thereof. Bortezomib or a boronic acid anhydride of Formula IA may be isolated by filtration, extraction, distillation, pH adjustment, concentration, decantation, or a combination thereof.

A fourth aspect of the present invention provides a process for the preparation of bortezomib or a boronic acid anhydride of Formula IA

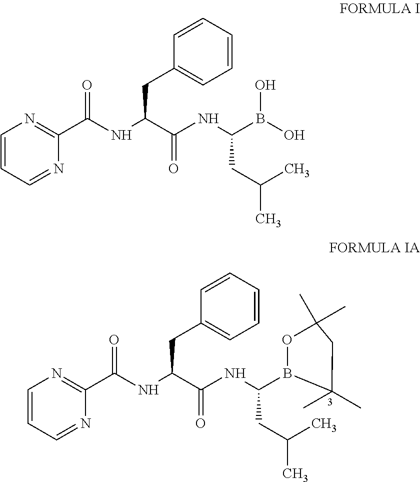 [SMILES: CC(C)C[C@H](NC(=O)[C@H](Cc1ccccc1)NC(=O)c1ncccn1)B(O)O ; CC(C)C[C@H](NC(=O)[C@H](Cc1ccccc1)NC(=O)c1ncccn1)B1OC(C)(C)CC1(C)C]

comprising:
a) coupling the (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts with N-(tert-butoxycarbonyl)-L-phenylalanine of Formula VI to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII,

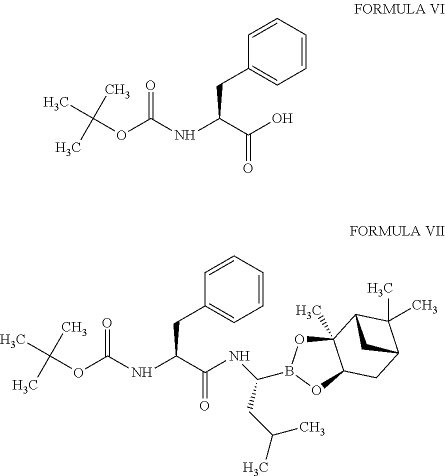 [SMILES: CC(C)(C)OC(=O)N[C@@H](Cc1ccccc1)C(=O)O ; CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]

b) deprotecting the compound of Formula VII to obtain N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts,

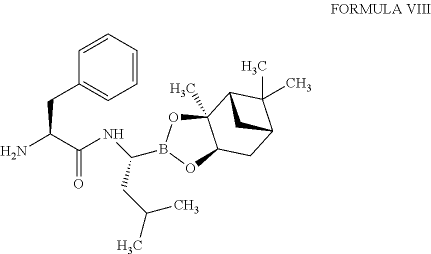 [SMILES: CC(C)C[C@H](NC(=O)[C@@H](N)Cc1ccccc1)B1O[C@@H]2C[C@@H]3C[C@@H](C3(C)C)[C@]2(C)O1]

c) coupling the compound of Formula VIII or its salts with pyrazine-2-carboxylic acid of Formula IX to obtain N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X, and

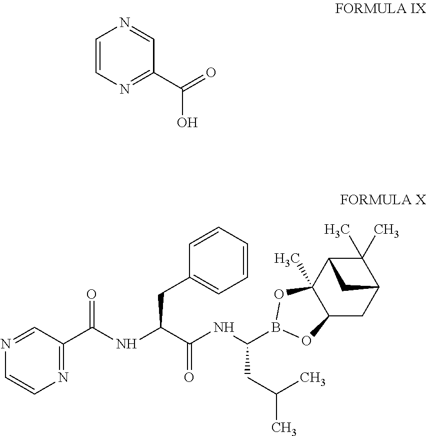 [SMILES: O=C(O)c1cnccn1 ; CC(C)C[C@H](NC(=O)[C@H](Cc1ccccc1)NC(=O)c1cnccn1)B1O[C@@H]2C[C@@H]3C[C@@H](C3(C)C)[C@]2(C)O1]

d) deprotecting the compound of Formula X to obtain bortezomib or a boronic acid anhydride of Formula IA,
   wherein at least any two of the compound of Formula VII of step a), compound of Formula VIII of step b) and compound of Formula X of step c) are not isolated in any solid form.

The (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts and N-(tert-butoxycarbonyl)-L-phenylalanine of Formula VI may be prepared according to the method provided in U.S. Publication 2005/240047 or PCT application WO 2009/004350. The compound of Formula V or its salt is coupled with the compound of Formula VI to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII. The compound of Formula V may be dissolved in an organic solvent and compound of Formula VI, a coupling agent and a base are added. The resultant reaction mixture may be stirred and cooled to about −10° to about 15° C. The coupling agent may be selected from the group consisting of O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate and 1-ethyl-3-(3-dimethylaminopropyl)carbodiimide. The base may be selected from the group consisting of metal alkoxides, alkali metal hydroxides, alkali metal carbonates, alkali metal hydrides and alkylamines. The organic solvent may be a polar solvent or a non polar solvent. The organic solvent may be selected from the group consisting of dichloromethane, dichloroethane, chloroform, dimethylformamide and 1,4-dioxane, or a mixture thereof. The reaction mixture may be stirred for about 1 hour to about 100 hours. The reaction mixture containing the compound of Formula VII may be subjected to layer separation followed by deprotection, or the reaction mixture may be directly subjected to deprotection to obtain the N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII, or salts thereof. The deprotection may be carried out with an acid. The acid may be selected from a group consisting of trifluoroacetic acid, hydrochloric acid, hydrobromic acid and sulfuric acid. The reaction mixture containing the compound Formula VIII or salts thereof may be subjected to layer separation followed by coupling with pyrazine-2-carboxylic acid of Formula IX, or the reaction mixture may be directly subjected to coupling with the compound of Formula IX to obtain N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X. The coupling reaction may involve the use of a coupling agent and a base. The coupling agent may be selected from the group consisting of O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate and 1-ethyl-3-(3-dimethylaminopropyl)carbodiimide. The base may be selected from the group consisting of metal alkoxides, alkali metal hydroxides, alkali metal carbonates, alkali metal hydrides and alkylamines. The temperature of the reaction mixture may be raised to about 20° C. to about 40° C. The reaction may be stirred for about 1 hour to about 24 hours. The reaction mixture may be optionally washed subsequently with water, phosphoric acid solution and potassium carbonate solution. The solvent from the reaction mixture containing the compound of Formula X may be optionally recovered partially under vacuum.

The compound of Formula X is deprotected to obtain bortezomib or a boronic acid anhydride of Formula IA. The deprotection may be carried out with an acid, an organic boronic acid acceptor and an alcoholic solvent. The acid may be an organic acid or inorganic acid, for example trifluoroacetic acid, hydrochloric acid or hydrobromic acid. The organic boronic acid acceptor may be, for example, isobutyl boronic acid. The alcoholic solvent may be selected from a group consisting of methanol, ethanol, n-propanol, propan-2-ol, butan-1-ol and butan-2-ol, or a mixture thereof. Bortezomib or a boronic acid anhydride of Formula IA may be isolated by filtration, extraction, distillation, pH adjustment, concentration, decantation, or a combination thereof. Bortezomib or a boronic acid anhydride of Formula IA may be optionally recrystallized with a chlorinated solvent, for example, dichloroethane, dichloromethane and chloroform or mixture thereof, nitrile solvent, for example, acetonitrile, and ester solvent, for example, ethyl acetate, methyl acetate and butyl acetate, or mixture thereof.

While the present invention has been described in terms of its specific embodiments, certain modifications and equivalents will be apparent to those skilled in the art and are intended to be included within the scope of the present invention.

### EXAMPLES

### Example 1

### Preparation of (3 as,4s,6s,7ar)-2-(1-Chloro-3-Methylbutyl)-3a,5,5-Trimethylhexahydro-4,6-Methano-1,3,2-Benzodioxaborole

Diisopropylamine (0.57 kg) and tetrahydrofuran (1.0 L) were added together and the mixture was cooled to −30° C. 2.5 M solution of butyl lithium in hexane (2.2 L) was added dropwise to the cooled mixture, and the temperature was maintained at −20° C. to −30° C. The mixture was stirred for 0.5 hours at −20° C. to −30° C. and a clear solution of lithium diisopropyl amide was obtained.

In a separate round bottomed flask, zinc chloride (1.3 kg) and tetrahydrofuran (6 L) were added together at 20° C. The mixture was stirred at 20° C. for 0.5 hours and a clear solution of zinc chloride was obtained.

In a separate round bottomed flask, (3aS,4S,6S,7aR)-3a,5,5-trimethyl-2-(2-methylpropyl)hexahydro-4,6-methano-1,3,2-benzodioxaborole (1 kg) and tetrahydrofuran (5 L) were added together at 20° C. Dichloromethane (1 L) was added to the mixture and the mixture was cooled to −70° C. Lithium diisopropylamide solution was added slowly to the mixture at −60° C. to −70° C. The mixture was stirred for 0.5 hours at −65° C. to −70° C. Zinc chloride solution was added slowly to the mixture at −60° C. to −70° C. The reaction mixture was stirred for 1.5 hours at −60° C. to −70° C. The temperature of mixture was raised to 10° C. in 2 hours to 3 hours and reaction progress was monitored by gas chromatography. Sulfuric acid (0.6 L) was added to the mixture at 10° C. to 15° C. and solvent was recovered under vacuum at 45° C. Hexanes (4 L) and water (4 L) were added slowly at 20° C. to the mixture and mixture was stirred for 0.5 hours at 20° C. Organic and aqueous layers were separated and aqueous layer was washed with hexanes (2 L). Combined organic layer was washed with water (3×3 L), concentrated under vacuum at 35° C. to obtain the title compound.

### Yield: 1.068 kg

### Example 2

### Preparation of 1,1,1-Trimethyl-N-{(1r)-3-Methyl-1-[(3 as,4s,6s,7ar)-3a,5,5-Trimethylhexahydro-4,6-Methano-1,3,2-Benzodioxaborol-2-Y1]Butyl}-N-(Trimethylsilyl)Silanamine

In a round bottomed flask, 2.5 M butyl lithium (1.43 L) was added at 20° C. The mixture was cooled to −5° C. Bis(trimethylsilyl)amine (0.57 kg) was added to the mixture at temperature of −5° C. to 0° C. After the addition of bis(trimethylsilyl)amine, temperature of reaction mixture was raised to 20° C. and mixture was stirred for 20 minutes at 20° C. to obtain lithium hexamethyldisilazide solution.

In a separate round bottomed flask, (3aS,4S,6S,7aR)-2-(1-chloro-3-methylbutyl)-3a,5,5-trimethylhexahydro-4,6-methano-1,3,2-benzodioxaborole (1 kg) and hexanes (8 L) were added and temperature of reaction mixture was cooled to −70° C. Lithium hexamethyldisilazide solution was added dropwise to the reaction mixture at −60° C. to −70° C. The mixture was stirred for 1 hour at −60° C. to −70° C. The temperature of the mixture was raised to 20° C. in 2 hours to 3 hours and the mixture was stirred for 15 hours. Reaction was monitored using gas chromatography. The mixture was filtered through a Celite® bed (0.1 kg) bed and the Celite® bed was washed with hexanes (1 L). Hexanes were recovered under vacuum at 35° C. to 40° C. to obtain the title compound.

### Yield: 1.32 kg

### Example 3

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine

1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine (1 kg) and diisopropyl ether (6 L) were added together and the mixture was cooled to −10° C. Trifluoroacetic acid (0.85 kg) was added dropwise to the mixture at −10° C. to −5° C. The reaction mixture was stirred at 0° C. to −10° C. for 2 hours. The mixture was filtered at 0° C. to −10° C., washed with diisopropyl ether (1 L) at 0° C. and dried under vacuum at 40° C. to obtain the title compound.

### Yield: 0.8 Kg

### Step B: Preparation of tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate

(1R)-3-methyl-1-[(3aS,4S,6S,7aR)-3a,5,5-trimethylhexahydro-4,6-methano-1,3,2-benzodioxaborol-2-yl]butan-1-aminium (1 kg), dichloromethane (8 L), O-(benzotriazol-1-yl)-N,N,N′,N′-tetramethyluronium tetrafluoroborate (0.93 kg) and N-(tert-butoxycarbonyl)-L-phenylalanine (0.7 kg) were added together and mixture was cooled to 0° C. N,N-Diisopropylethylamine (1.4 L) was added to the mixture at 0° C. to 5° C. The mixture was stirred for 1 hour at 0° C. Temperature of the reaction mixture was raised to 20° C. and the mixture was stirred for 1 hour. The mixture was washed subsequently with water (2×5 L), 1% phosphoric acid solution (2×5 L), potassium carbonate solution (3 L) and sodium chloride solution (3 L). The organic solvent was recovered under vacuum to obtain the title compound.

### Yield: 1.35 kg

### Step C: Preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide

tert-Butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate (1 kg) and dichloromethane (6 L) were added together and the mixture was cooled to 0° C. Hydrogen chloride gas was purged in to the reaction mixture and the reaction mixture was stirred until completion of the reaction. Dichloromethane was recovered under vacuum to obtain the title compound.

### Yield: 0.83 kg

### Step D: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

N-{(1S)-3-methyl-1-[(3aS,4S,6S,7aS)-3a,5,5-trimethylhexahydro-4,6-methano-1,3,2-benzodioxaborol-2-yl]butyl}phenylalanine amide (1 kg), pyrazine-2-carboxylic acid (0.305 kg), dichloromethane (10 L) and O-(benzotriazol-1-yl)-N,N,N′,N′-tetramethyluronium tetrafluoroborate (0.79 kg) were added together and the temperature of the mixture was maintained at 0° C. The N,N-diisopropylethylamine (1 L) was added to the reaction mixture at 0° C. to 5° C. The mixture was stirred for 1 hour at 0° C. and the temperature of the reaction mixture was raised to 20° C. The mixture was stirred for 1 hour at 20° C. and solvent was recovered under vacuum partially to obtain a residue. Ethyl acetate (12 L) was added to the residue and the mixture was subsequently washed with water (2×5 L), 1% phosphoric acid solution (2×5 L), potassium carbonate solution (3 L) and sodium chloride solution (3 L). The organic solvent was recovered under vacuum to obtain the title compound.

### Yield: 1.3 kg

### Step E: Preparation of [(1R)-3-methyl-1-[[(2S)-1-oxo-3-phenyl-2-[(pyrazinylcarbonyl)amino]propyl]amino]butyl]boronic acid (Bortezomib)

N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide (1 kg), methanol (12 L) and hexanes (12 L) were added together at 20° C. The reaction mixture was cooled to 0° C. and 1N hydrochloric acid (4.5 L) was added to the mixture at 0° C. to 5° C. The isobutyl boronic acid (0.25 kg) was added to the reaction mixture and the temperature was raised to 20° C. The reaction mixture was stirred until completion of the reaction and two layers were separated. The methanol layer was washed with hexanes (8 L) and methanol was recovered under vacuum. The residue was basified with 8% sodium hydroxide solution (8.2 L). The aqueous layer was washed with dichloromethane (6 L) and 1N hydrochloride acid solution (2 L) was added to the aqueous layer at 0° C. to 5° C. Mixture was extracted with dichloromethane (14 L), concentrated under vacuum at 20° C. to obtain the title compound.

### Yield: 0.63 Kg

### Example 4

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine

1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine (1 kg) and diisopropyl ether (6 L) were added together and the mixture was cooled to −10° C. Trifluoroacetic acid (0.85 kg) was added dropwise to the mixture at −10° C. to −5° C. The reaction mixture was stirred at 0° C. to −10° C. for 2 hours. The mixture was filtered at 0° C. to −10° C., washed with diisopropyl ether (1 L) at 0° C. and dried under vacuum at 40° C. to obtain the title compound.

### Yield: 0.73 kg

### Step B: Preparation of tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate

(1R)-3-methyl-1-[(3aS,4S,6S,7aR)-3a,5,5-trimethylhexahydro-4,6-methano-1,3,2-benzodioxaborol-2-yl]butan-1-aminium (1 kg), dichloromethane (8 L), O-(benzotriazol-1-yl)-N,N,N′,N′-tetramethyluronium tetrafluoroborate (0.93 kg) and N-(tert-butoxycarbonyl)-L-phenylalanine (0.7 kg) were added together and the mixture was cooled to 0° C. N,N-Diisopropylethylamine (1.4 L) was added to the mixture at 0° C. to 5° C. The mixture was stirred for 1 hour at 0° C. Temperature of the reaction was raised to 20° C. and the mixture was stirred for 1 hour. The mixture was washed subsequently with water (2×5 L), 1% phosphoric acid solution (2×5 L), potassium carbonate solution (3 L) and sodium chloride solution (3 L). The organic solvent was recovered under vacuum to obtain the title compound.

### Yield: 1.38 kg

### Step C: Preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide

tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate (1 kg) and toluene (10 L) were added together and the mixture was cooled to 0° C. Hydrogen chloride gas was purged in to the reaction mixture and reaction mixture was stirred for 1 hour at 0° C. The mixture was filtered, washed with toluene (1 L) and dried under vacuum at 40° C. to obtain the title compound.

### Yield: 0.52 kg

### Step D: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

N-{(1S)-3-methyl-1-[(3aS,4S,6S,7aS)-3a,5,5-trimethylhexahydro-4,6-methano-1,3,2-benzodioxaborol-2-yl]butyl}phenylalanine amide (1 kg), pyrazine-2-carboxylic acid (0.305 kg), dichloromethane (10 L) and O-(benzotriazol-1-yl)-N,N,N′,N′-tetramethyluronium tetrafluoroborate (0.79 kg) were added together and temperature of the mixture was maintained at 0° C. The N,N-Diisopropylethylamine (1 L) was added to the reaction mixture at 0° C. to 5° C. The mixture was stirred for 1 hour at 0° C. and temperature of the reaction mixture was raised to 20° C. The mixture was stirred for 1 hour at 20° C. and solvent was recovered under vacuum partially to obtain a residue. Ethyl acetate (12 L) was added to the residue and the mixture was subsequently washed with (2×5 L), 1% phosphoric acid solution (2×5 L), potassium carbonate solution (3 L) and sodium chloride (3 L) solution. The organic solvent was recovered under vacuum to obtain the title compound.

### Yield: 1.098 Kg

### Step E: Preparation of [(1R)-3-methyl-1-[[(2S)-1-oxo-3-phenyl-2-[(pyrazinylcarbonyl)amino]propyl]amino]butyl]boronic acid (Bortezomib)

The reaction was carried out similar to Step E of Example 3.

### Yield: 0.56 kg

### Example 5

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine

1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine (1 kg) and diisopropyl ether (6 L) were added together and mixture was cooled to −10° C. Trifluoroacetic acid (0.85 kg) was added dropwise to the reaction mixture at −10° C. to −5° C. The reaction mixture was stirred at 0° C. to −10° C. for 2 hours. The mixture was filtered at 0° C. to −10° C., washed with diisopropyl ether (1 L) at 0° C. and dried under vacuum at 40° C. to obtain the title compound.

### Yield: 0.8 Kg

### Step B: Preparation of tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate

(1R)-3-Methyl-1-[(3aS,4S,6S,7aR)-3a,5,5-trimethylhexahydro-4,6-methano-1,3,2-benzodioxaborol-2-yl]butan-1-aminium (1 kg), dimethylformamide (10 L), O-(benzotriazol-1-yl)-N,N,N′,N′-tetramethyluronium tetrafluoroborate (0.93 kg) and N-(tert-butoxycarbonyl)-L-phenylalanine (0.7 kg) were added together and the mixture was cooled to 0° C. N,N-diisopropylethylamine (1.26 L) was added to the reaction mixture at 0° C. to 5° C. The mixture was stirred for 1 hour at 0° C. The temperature of the reaction was raised to 20° C., water (150 L) was added to the mixture and the mixture was stirred for 2 hours. The mixture was filtered and dried under vacuum at 30° C. to obtain the title compound.

### Yield: 1.25 kg

### Step C: Preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide

tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate (1 kg) and toluene (10 L) were added together and mixture was cooled to 0° C. Hydrogen chloride gas was purged in to the reaction mixture and reaction mixture was stirred for 1 hour at 0° C. The mixture was filtered, washed with toluene (1 L) and dried under vacuum at 40° C. to obtain the title compound.

### Yield: 0.89 kg

### Step D: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

N-{(1S)-3-methyl-1-[(3aS,4S,6S,7aS)-3a,5,5-trimethylhexahydro-4,6-methano-1,3,2-benzodioxaborol-2-yl]butyl}phenylalanine amide (1 kg), pyrazine-2-carboxylic acid (0.305 kg), dichloromethane (10 L) and O-(benzotriazol-1-yl)-N,N,N′,N′-tetramethyluronium tetrafluoroborate (0.79 kg) were added together and the temperature of the mixture was maintained at 0° C. N,N-diisopropylethylamine (1 L) was added to the reaction mixture at 0° C. to 5° C. The mixture was stirred for 1 hour at 0° C. and temperature of reaction mixture was raised to 20° C. The mixture was stirred for 1 hour at 20° C. and solvent was recovered under vacuum. Ethyl acetate (12 L) was added to the residue and mixture was subsequently washed with water (2×5 L), 1% phosphoric acid solution (2×L), potassium carbonate solution (3 L) and sodium chloride (3 L) solution. The organic solvent was recovered under vacuum to obtain the title compound.

### Yield: 1.05 Kg

### Step E: Preparation of [(1R)-3-methyl-1-[[(2S)-1-oxo-3-phenyl-2-[(pyrazinylcarbonyl)amino]propyl]amino]butyl]boronic acid (bortezomib)

The reaction was carried out similar to Step E of Example 3.

### Yield: 0.438 Kg

### Example 6

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine

1,1,1-Trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine (1 kg) and diisopropyl ether (6 L) were added together and mixture was cooled to −10° C. Trifluoroacetic acid (0.85 kg) was added dropwise at −10° C. to −5° C. The reaction mixture was stirred at 0° C. to −10° C. for 2 hours. The mixture was filtered at 0° C. to −10° C., washed with diisopropyl ether (1 L) at 0° C. and dried under vacuum at 40° C. to obtain the title compound.

### Yield: 0.73 kg

### Step B: Preparation of tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate

(1R)-3-methyl-1-[(3aS,4S,6S,7aR)-3a,5,5-trimethylhexahydro-4,6-methano-1,3,2-benzodioxaborol-2-yl]butan-1-aminium (1 kg), dimethylformamide (10 L), O-(benzotriazol-1-yl)-N,N,N′,N′-tetramethyluronium tetrafluoroborate (0.93 kg) and N-(tert-butoxycarbonyl)-L-phenylalanine (0.7 kg) were added together and mixture was cooled to 0° C. N,N-diisopropylethylamine (1.26 L) was added at 0° C. to 5° C. The mixture was stirred for 1 hour at 0° C. The temperature of the reaction mixture was raised to 20° C. and water (150 L) was added to the mixture and stirred for 2 hours. The mixture was filtered to obtain the title compound.

### Yield: 1.22 kg

### Step C: Preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide

tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate (1 kg) and toluene (10 L) were added together and the mixture was cooled to 0° C. Hydrogen chloride gas was purged in to the reaction mixture and the reaction mixture was stirred for 1 hour at 0° C. The mixture was filtered, washed with toluene (1 L) and dried under vacuum to obtain the title compound.

### Yield: 0.879 kg

### Step D: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

N-{(1S)-3-methyl-1-[(3aS,4S,6S,7aS)-3a,5,5-trimethylhexahydro-4,6-methano-1,3,2-benzodioxaborol-2-yl]butyl}phenylalanine amide (1 kg), pyrazine-2-carboxylic acid (0.275 kg), dimethylformamide (10 L) and O-(benzotriazol-1-yl)-N,N,N′,N′-tetramethyluronium tetrafluoroborate (0.79 kg) were added together and the temperature of the mixture was maintained at 0° C. The N,N-diisopropylethylamine (1.08 L) was added to the reaction mixture at 0° C. to 5° C. The mixture was stirred for 5 hours at 0° C. Water (150 L) was added to the mixture and the mixture was stirred for 0.5 hours. The solid obtained was filtered, washed with water (20 L×2) and dried under vacuum at 30° C. to obtain the title compound.

### Yield: 0.926 kg

### Step E: Preparation of [(1R)-3-methyl-1-[[(2S)-1-oxo-3-phenyl-2-[(pyrazinylcarbonyl)amino]propyl]amino]butyl]boronic acid (bortezomib)

The reaction was carried out similar to Step E of Example 3.

### Yield: 0.448 Kg

### Example 7

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

Bortezomib (1 g) and dichloromethane (5 mL) were added together and reaction mixture was stirred for 2 hours. The mixture was filtered, washed with dichloromethane (4 mL) and dried under vacuum at 40° C. to obtain the title compound.

### Yield: 0.7 g

### Example 8

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate

Trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine (1 kg), dichloromethane (8 L), O-(benzotriazol-1-yl)-N,N,N′,N′-tetramethyluronium tetrafluoroborate (0.915 kg) and N-(tert-butoxycarbonyl)-L-phenylalanine (0.69 kg) were added together and mixture was cooled to 0° C. N,N-diisopropylethylamine (1.26 L) was added to the reaction mixture at 0° C. to 5° C. The mixture was stirred for 1 hour at 0° C. The temperature of the reaction was raised to 20° C. and mixture was stirred for 1 hour. Mixture was washed subsequently with water (2×5 L), 1% phosphoric acid solution (5 L), 2.5% potassium carbonate solution (5 L) and water (2×5 L). The organic solvent was recovered under vacuum to obtain the title compound.

### Yield: 1.475 kg

### Step B: Preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide

tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate (1 kg) and toluene (10 L) were added together and the mixture was cooled to 0° C. Hydrogen chloride gas was purged in to the reaction mixture and the reaction mixture was stirred for 1 hour at 0° C. The reaction mixture was concentrated to a volume of 3 L. The mixture was filtered at 0° C., washed with toluene (0.5 L) and dried under vacuum at 40° C. to obtain the title compound.

### Yield: 0.665 kg

### Step C: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

N-{(1S)-3-methyl-1-[(3aS,4S,6S,7aS)-3a,5,5-trimethylhexahydro-4,6-methano-1,3,2-benzodioxaborol-2-yl]butyl}phenylalanine amide (1 kg), pyrazine-2-carboxylic acid (0.275 kg), dimethylformamide (10 L) and O-(benzotriazol-1-yl)-N,N,N′,N′-tetramethyluronium tetrafluoroborate (0.79 kg) were added together and the temperature of the mixture was maintained at 0° C. Diisopropylethyl amine (1.08 L) was added to the reaction mixture at 0° C. to 5° C. The mixture was stirred for 4.5 hours at 0° C. Water (150 L) was added to the mixture and the mixture was stirred for 0.5 hours. The solid was filtered and washed with water (2×20 L) and dried under vacuum to obtain the title compound.

### Yield: 1.00 Kg

### Step D: Preparation of [(1R)-3-methyl-1-[[(2S)-1-oxo-3-phenyl-2-[(pyrazinylcarbonyl)amino]propyl]amino]butyl]boronic acid (bortezomib)

N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide (1 kg), methanol (12 L) and hexanes (12 L) were added together at 20° C. The reaction mixture was cooled to 0° C. and 1N hydrochloric acid (4.36 L) was added to the mixture at 0° C. to 5° C. Isobutyl boronic acid (0.24 kg) was added to the mixture and the temperature was raised to 20° C. The reaction mixture was stirred till completion of the reaction and two layers were separated. The methanol layer was washed with hexanes (5 L) and methanol was recovered under vacuum to obtain a residue. The residue was basified with 25% w/v sodium hydroxide solution (1.4 L). The aqueous layer was washed with dichloromethane (2×2 L) and 1N hydrochloric acid solution (2 L) was added to the aqueous layer at 20° C. The mixture was extracted with dichloromethane (4 L) and concentrated under vacuum at 20° C. to obtain the title compound.

### Yield: 0.477 kg

### Example 9

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

### Step A: Preparation of N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide

Trifluoroacetic acid salt of (1R)-3-methyl-1-[(3aS,4S,6S,7aR)-3a,5,5-trimethylhexahydro-4,6-methano-1,3,2-benzodioxaborol-2-yl]butan-1-amine (1 kg), dichloromethane (8 L) were added together and the reaction mixture was cooled to 0° C. N,N-diisopropylethylamine (1.84 L), O-(benzotriazol-1-yl)-N,N,N′,N′-tetramethyluronium tetrafluoroborate (0.745 kg) and N-(tert-butoxycarbonyl)-L-phenylalanine (0.56 kg) were added to the mixture at 0° C. to 5° C. The mixture was stirred until the completion of reaction at 0° C. The mixture was washed subsequently with water (7 L), 1% phosphoric acid solution (7 L), potassium carbonate solution (7 L) and water (7 L). The organic and aqueous layers were separated. The organic layer was cooled to 0° C. and sulfuric acid (0.34 L) was added to the organic layer at 0° C. The mixture was stirred until completion of the reaction. The reaction was quenched using 10% aqueous sodium bicarbonate solution (10 L) and the organic layer was separated and washed with water (5 L). The organic layer was separated and cooled to 0° C. N,N-diisopropylethylamine (0.56 kg), pyrazine-2-carboxylic acid (0.203 kg) and O-(benzotriazol-1-yl)-N,N,N′,N′-tetramethyluronium tetrafluoroborate (0.59 kg) were added to the organic layer at 0° C. The temperature of the reaction mixture was raised to 20° C. The reaction mixture was stirred for 12 hours at 20° C. The reaction mixture was subsequently washed with water (6 L), 1% phosphoric acid solution (6 L), 2.5% potassium carbonate solution (6 L) and water (6 L). The organic solvent was recovered under vacuum to obtain the title compound.

### Yield: 0.98 kg

### Step B: Preparation of [(1R)-3-methyl-1-[[(2S)-1-oxo-3-phenyl-2-[(pyrazinylcarbonyl)amino]propyl]amino]butyl]boronic acid (bortezomib)

N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide (1 kg), methanol (7 L), hexanes (7 L) and isobutyl boronic acid (0.197 kg) were added together at 25° C. 1N hydrochloride acid (7 L) was added to the reaction mixture at 20° C. to 30° C. The mixture was stirred until completion of reaction and two layers were separated. The methanol layer was washed with hexanes (3 L) and methanol was recovered under vacuum completely to obtain a residue. Dichloromethane (3 L) was added to the residue and basified with 3.45% sodium hydroxide solution (2.25 L). The aqueous layer was washed with dichloromethane (3 L) and 1N hydrochloride acid solution (2 L) was added to the aqueous layer at 0° C. to 5° C. The mixture was extracted with dichloromethane (5 L) and concentrated under vacuum at 20° C. to obtain the title compound.

### Yield: 0.52 Kg

### Example 10

### Preparation of [(1r)-3-Methyl-1-[[(2s)-1-Oxo-3-Phenyl-2-[(Pyrazinylcarbonyl)Amino]Propyl]Amino]Butyl]Boronic Acid (Bortezomib)

(1R)-3-methyl-1-[(3aS,4S,6S,7aR)-3a,5,5-trimethylhexahydro-4,6-methano-1,3,2-benzodioxaborol-2-yl]butan-1-aminium (1 kg), dichloromethane (8 L), O-(benzotriazol-1-yl)-N,N,N′,N′-tetramethyluronium tetrafluoroborate (0.93 kg) and N-(tert-butoxycarbonyl)-L-phenylalanine (0.7 kg) were added together and the mixture was cooled to 0° C. N,N-diisopropylethylamine (1.4 L) was added to the mixture at 0° C. to 5° C. and the mixture was stirred for 1 hour at 0° C. Hydrochloride gas was purged in to the reaction mixture and the mixture was stirred until the completion of reaction. Pyrazine-2-carboxylic acid (0.327 kg) and O-(benzotriazol-1-yl)-N,N,N′,N′-tetramethyluronium tetrafluoroborate (0.93 kg) were added to the mixture and temperature of the mixture was maintained at 0° C. The N,N-diisopropylethylamine (3.67 L) was added to the reaction mixture at 0° C. to 5° C. The mixture was stirred for 1 hour at 0° C. and the temperature of the reaction mixture was raised to 20° C. The mixture was stirred for 1 hour at 20° C. The reaction mixture was subsequently washed with water (2×3 L), 1% phosphoric acid solution (2×7 L), 2.5% sodium bicarbonate solution (3 L) and water (3 L). The organic solvent was recovered partially under vacuum to obtain an oil. Methanol (9.62 l), hexanes (9.62 l) and isobutyl boronic acid (0.27 kg) were added to the oil at 20° C. 1N Hydrochloride acid (7.2 L) was added to the mixture at 25° C. The mixture was stirred until completion of reaction and the layers were separated. The methanol layer was washed with hexanes (3 L) and methanol was recovered under vacuum. The residue was basified with 8% sodium hydroxide solution (7.2 L). The aqueous solution was washed with dichloromethane (3×3 L) and 1N hydrochloride acid solution (2 L) was added to the aqueous layer at 20° C. The mixture was extracted with dichloromethane (3 L) and concentrated under vacuum at 20° C. to obtain the title compound.

Yield: 0.837 Kg

We claim:

1. A process for the preparation of (3aS,4S,6S,7aR)-2-(1-chloro-3-methylbutyl)-3a,5,5-trimethylhexahydro-4,6-methano-1,3,2-benzodioxaborole of Formula III or its salts, 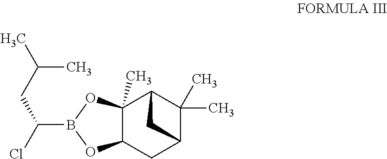 [SMILES: CC(C)C[C@@H](Cl)B1O[C@@H]2C[C@@H]3C[C@@H](C3(C)C)[C@]2(C)O1]
wherein the process comprises reacting (3aS,4S,6S,7aR)-3a,5,5-trimethyl-2-(2-methylpropyl)hexahydro-4,6-methano-1,3,2-benzodioxaborole of Formula II or its salts 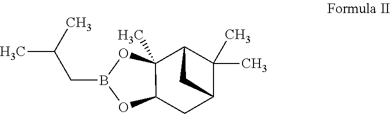 [SMILES: CC(C)CB1O[C@@H]2C[C@@H]3C[C@@H](C3(C)C)[C@]2(C)O1]
with lithium amide base and Lewis acid in the presence of a water-miscible ether solvent and a halogenated hydrocarbon solvent to obtain (3aS,4S,6S,7aR)-2-(1-chloro-3-methylbutyl)-3a,5,5-trimethylhexahydro-4,6-methano-1,3,2-benzodioxaborole of Formula III or its salts, wherein the halogenated hydrocarbon solvent is less than about 3.8 molar equivalents per mole of the compound of Formula II.

2. A process for the preparation of bortezomib of Formula I or a boronic acid anhydride of Formula IA comprising: 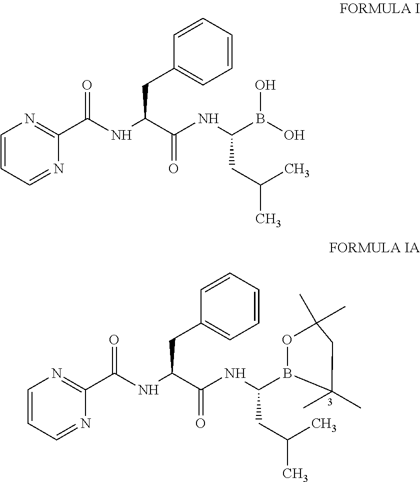 [SMILES: CC(C)C[C@H](NC(=O)[C@H](Cc1ccccc1)NC(=O)c1ncccn1)B(O)O ; CC(C)C[C@H](NC(=O)[C@H](Cc1ccccc1)NC(=O)c1ncccn1)B1OC(C)(C)CC1(C)C]
a) reacting (3aS,4S,6S,7aR)-3a,5,5-trimethyl-2-(2-methylpropyl)hexahydro-4,6-methano-1,3,2-benzodioxaborole of Formula II or its salts 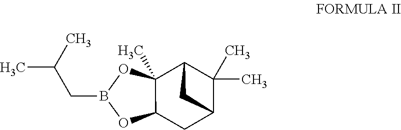 [SMILES: CC(C)CB1O[C@@H]2C[C@@H]3C[C@@H](C3(C)C)[C@]2(C)O1]
with lithium amide base and Lewis acid in the presence of a water-miscible ether solvent and a halogenated hydrocarbon solvent to obtain (3aS,4S,6S,7aR)-2-(1-chloro-3-methylbutyl)-3a,5,5-trimethylhexahydro-4,6-methano-1,3,2-benzodioxaborole of Formula III or its salts, 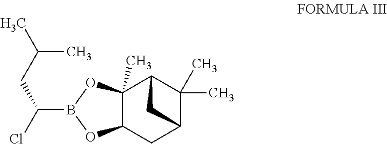 [SMILES: CC(C)C[C@@H](Cl)B1O[C@@H]2C[C@@H]3C[C@@H](C3(C)C)[C@]2(C)O1]
wherein the halogenated hydrocarbon solvent is less than about 3.8 molar equivalents per mole of compound of Formula II;
b) reacting the compound of Formula III or its salts with M¹-N(Si(CH₃)₃)₂, where M¹ is an alkali metal to obtain 1,1,1-trimethyl-N-{(1R)-3-methyl-1-[(3aS,4S,6S,7aR)-3a,5,5-trimethylhexahydro-4,6-methano-1,3,2-benzodioxaborol-2-yl]butyl}-N-(trimethylsilyl)silanamine of Formula IV or its salts; 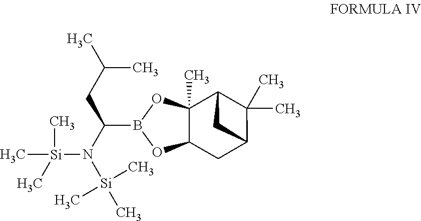
c) desilylating the compound of Formula IV or its salts to obtain (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts; 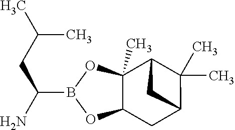 [SMILES: CC(C)C[C@H](N)B1O[C@@H]2C[C@@H]3C[C@@H](C3(C)C)[C@]2(C)O1]
d) coupling the compound of Formula V or its salts with N-(tert-butoxycarbonyl)-L-phenylalanine of Formula VI to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII; 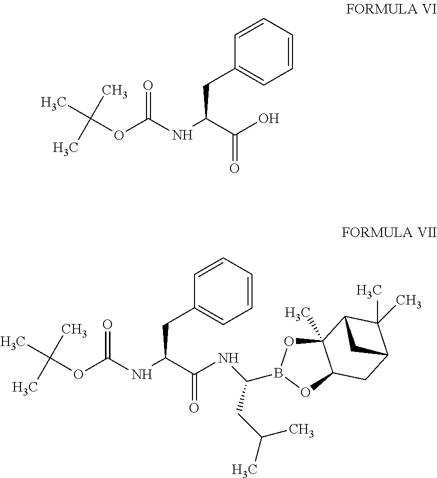 [SMILES: CC(C)(C)OC(=O)N[C@@H](Cc1ccccc1)C(=O)O ; CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]
e) deprotecting the compound of Formula VII in the presence of a hydrocarbon solvent to obtain N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts; 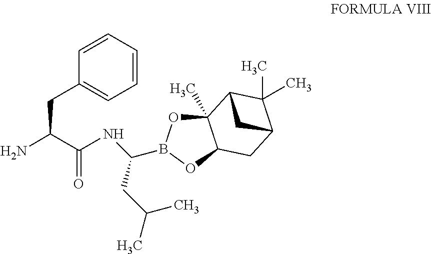 [SMILES: CC(C)C[C@H](NC(=O)[C@@H](N)Cc1ccccc1)B1O[C@@H]2C[C@@H]3C[C@@H](C3(C)C)[C@]2(C)O1]
f) coupling the compound of Formula VIII or its salts with pyrazine-2-carboxylic acid of Formula IX to obtain N-{(1R)-3-methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X; and 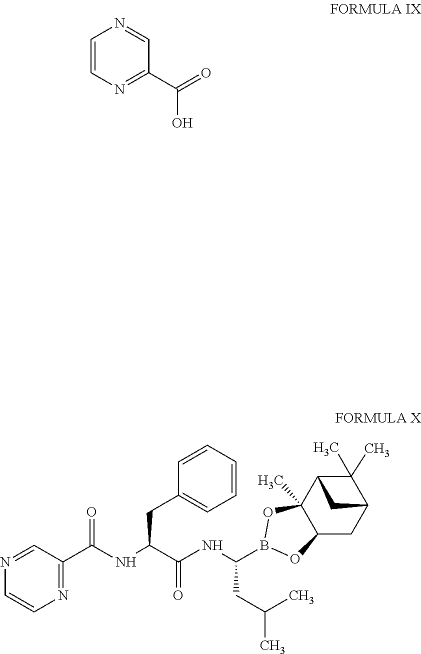 [SMILES: O=C(O)c1cnccn1 ; CC(C)C[C@H](NC(=O)[C@H](Cc1ccccc1)NC(=O)c1cnccn1)B1O[C@@H]2C[C@@H]3C[C@@H](C3(C)C)[C@]2(C)O1]
g) deprotecting the compound of Formula X to obtain bortezomib or a boronic acid anhydride of Formula IA.

3. A process according to claim 1 or 2, wherein the lithium amide base is lithium diisopropylamide, lithium diethylamide or lithium dimethylamide.

4. A process according to claim 1 or 2, wherein the Lewis acid is zinc chloride, zinc bromide, boron trifluoride, boron trichloride, ferric chloride, ferric bromide or aluminum trichloride.

5. A process according to claim 1 or 2, wherein the halogenated hydrocarbon solvent is dichloromethane.

6. A process according to claim 2, wherein M¹-N(Si(CH₃)₃)₂ is lithium bis(trimethylsilyl)amide, sodium bis(trimethylsilyl)amide or potassium bis(trimethylsilyl)amide.

7. A process according to claim 2, wherein desilylation is carried out with the acid.

8. A process according to claim 7, wherein the acid is trifluoroacetic acid.

9. A process according to claim 2, wherein the coupling agent in step d) and step f) is O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate or 1-ethyl-3-(3-dimethylaminopropyl)carbodiimide.

10. A process for the preparation of N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts, 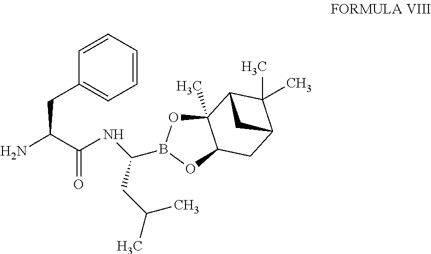 [SMILES: CC(C)C[C@H](NC(=O)[C@@H](N)Cc1ccccc1)B1O[C@@H]2C[C@@H]3C[C@@H](C3(C)C)[C@]2(C)O1]
wherein the process comprises contacting tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII 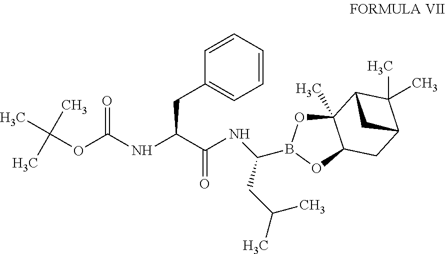 [SMILES: CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]
with an acid in the presence of a hydrocarbon solvent to obtain the compound of Formula VIII or its salts.

11. A process according to claim 2 or 10, wherein the hydrocarbon solvent is toluene or xylene or mixture thereof.

12. A process for the preparation of bortezomib or a boronic acid anhydride of Formula IA comprising: 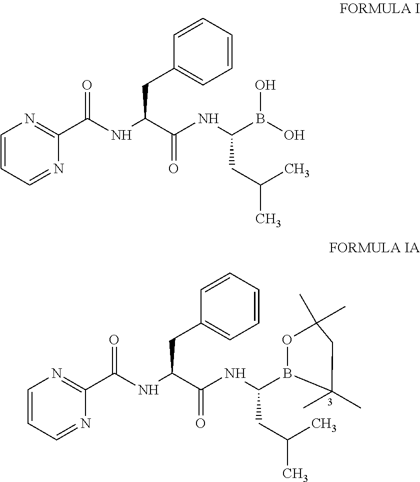 [SMILES: CC(C)C[C@H](NC(=O)[C@H](Cc1ccccc1)NC(=O)c1ncccn1)B(O)O ; CC(C)C[C@H](NC(=O)[C@H](Cc1ccccc1)NC(=O)c1ncccn1)B1OC(C)(C)CC1(C)C]
a) coupling the (1R)-3-methyl-1-[(3aS,4S,6S,7aR)-3a,5,5-trimethylhexahydro-4,6-methano-1,3,2-benzodioxaborol-2-yl]butan-1-amine of Formula V or its salts with N-(tert-butoxycarbonyl)-L-phenylalanine of Formula VI to obtain tert-butyl [1-({(1S)-3-methyl-1-[(3aS,4S,6S,7aS)-3a,5,5-trimethylhexahydro-4,6-methano-1,3,2-benzodioxaborol-2-yl]butyl}amino)-1-oxo-3-phenylpropan-2-yl]carbamate of Formula VII, 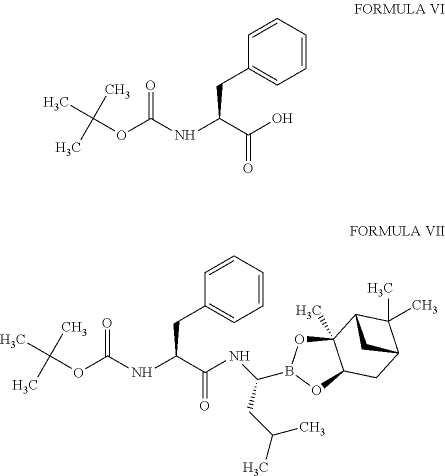 [SMILES: CC(C)(C)OC(=O)N[C@@H](Cc1ccccc1)C(=O)O ; CC(C)C[C@H](NC(=O)[C@H](Cc1ccccc1)NC(=O)OC(C)(C)C)B1O[C@@H]2C[C@@H]3C[C@@H](C3(C)C)[C@]2(C)O1]
b) deprotecting the compound of Formula VII to obtain N-{(1S)-3-methyl-1-[(3aS,4S,6S,7aS)-3a,5,5-trimethylhexahydro-4,6-methano-1,3,2-benzodioxaborol-2-yl]butyl}phenylalanine amide of Formula VIII or its salts, 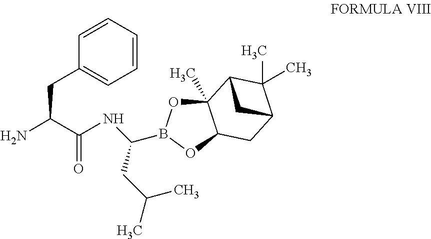 [SMILES: CC(C)C[C@H](NC(=O)[C@@H](N)Cc1ccccc1)B1O[C@@H]2C[C@@H]3C[C@@H](C3(C)C)[C@]2(C)O1]
c) coupling the compound of Formula VIII or its salts with pyrazine-2-carboxylic acid of Formula IX to obtain N-{(1R)-3-Methyl-1-[(3aS,4S,6S,7aR)-3a,5,5-trimethylhexahydro-4,6-methano-1,3,2-benzodioxaborol-2-yl]butyl}-Nα-(pyrazin-2-ylcarbonyl)-L-phenylalaninamide of Formula X, and 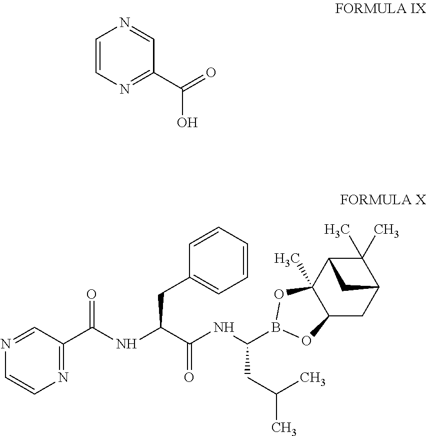 [SMILES: O=C(O)c1cnccn1 ; CC(C)C[C@H](NC(=O)[C@H](Cc1ccccc1)NC(=O)c1cnccn1)B1O[C@@H]2C[C@@H]3C[C@@H](C3(C)C)[C@]2(C)O1]
d) deprotecting the compound of Formula X to obtain bortezomib or a boronic acid anhydride of Formula IA,
wherein at least any two of the compound of Formula VII of step a), compound of Formula VIII of step b) and compound of Formula X of step c) are not isolated in any solid form.

13. A process according to claim 12, wherein the coupling agent in step a) and step c) is O-(benzotriazol-1-yl)-N,N,N′,N′-tetramethyluronium tetrafluoroborate (TBTU), dicyclohexylcarbodiimide, O-benzotriazole-N,N,N′,N′-tetramethyl-uronium-hexafluoro-phosphate, benzotriazol-1-yl-oxytripyrrolidinophosphonium hexafluorophosphate or 1-ethyl-3-(3-dimethylaminopropyl)carbodiimide.

14. A process according to claim 12, wherein step b) is carried out with the acid.

15. A process according to claim 14, wherein the acid is trifluoroacetic acid, hydrochloric acid, hydrobromic acid or sulfuric acid.

16. A process according to claim 15, wherein the step d) is carried out with the acid and an organic boronic acid acceptor.

17. A process according to claim 16, wherein the acid is trifluoroacetic acid, hydrochloric acid, hydrobromic acid or sulfuric acid.

18. A process according to claim 16, wherein the organic boronic acid acceptor is isobutyl boronic acid.
